(19) United States
(12) Patent Application Publication
(10) Pub. No.: US 2012/0329944 A1
(43) Pub. Date: Dec. 27, 2012

(54) SEMIAROMATIC POLYAMIDE, PROCESS FOR PREPARING SAME, COMPOSITION COMPRISING SUCH A POLYAMIDE AND USES THEREOF

(75) Inventors: Thierry Briffaud, Caorches Saint Nicolas (FR); Vincent Ferreiro, Pont du Chateau (FR)

(73) Assignee: Arkema France, Colombes (FR)

(21) Appl. No.: 13/518,695

(22) PCT Filed: Dec. 21, 2010
(86) PCT No.: PCT/FR10/52840

§ 371 Date: Sep. 12, 2012

(30) Foreign Application Priority Data
Dec. 24, 2009 (FR) 09.59598

(51) Int. Cl. C08G 69/10; C08L 77/10; C08G 69/14

(52) U.S. Cl. 524/607; 528/323; 528/331

(57) ABSTRACT

The invention relates to a semiaromatic polyamide, to the process for preparing same, to a composition comprising such a polyamide and to the uses thereof.

This polyamide consists of 70 to 95 mol % of a first repeating unit obtained from the polycondensation of at least one first linear or branched aliphatic diamine comprising from 10 to 36 carbon atoms and of at least one aromatic dicarboxylic acid, and of 5 to 30 mol % of a second repeating unit obtained from at least one lactam and/or from at least one aminocarboxylic acid comprising from 9 to 12 carbon atoms.

### FIELD OF THE INVENTION

The present invention relates to a semiaromatic polyamide, the process for preparing same and the uses thereof, especially in the manufacture of various articles, such as electronic components intended for electrical or electronic equipment in the field of road transport and of road or railway traffic, in the aeronautical field, audio/video field, or field of video games and also in the industrial sector.

The invention also relates to a composition comprising such a semiaromatic polyamide and also to the uses of this composition, in particular in the manufacture of all or some of the electronic components that can be used in the sectors that have just been listed above.

### PRIOR ART AND TECHNICAL PROBLEM

Currently, in the electronics field, the manufacture of electronic circuits increasingly uses surface-mount technology (SMT). This technology makes it possible to place the electronic components, of reduced size, directly on a printed circuit board, previously covered with a brazing composition. These electronic components may especially be light-emitting diode (or LED) reflectors, switches or connectors.

The soldering of such electronic components to the printed circuit board, which takes place by means of the brazing composition, is carried out by passing the assembly into a melting furnace.

These brazing compositions are usually based on thermoplastic polymers. Such polymers must of course be chosen so as to withstand the high temperatures of the melting furnaces but also so as not to allow the electronic circuits to be deformed. It is necessary in particular to seek out polymers that make it possible to avoid “blistering”, i.e. the formation of blistering, on the surface of these electronic circuits.

Among the thermoplastic polymers capable of being used in the implementation of this SMT technology, document US 2004/0077769 describes a polyamide-based composition comprising:
from 20 to 80% by weight of a polyamide or a blend of polyamides having a melting point of greater than 280° C.;
from 5 to 60% by weight of at least one filler or reinforcing agent;
from 5 to 35% by weight of at least one flame retardant; and
from 1 to 10% by weight of at least one flame retardant synergist.

The polyamide according to document US 2004/0077769 comprises repeating units that derive:
(i) from terephthalic acid or a derivative thereof and, optionally, from one or more other aromatic or aliphatic diacids or derivatives thereof;
(ii) from one or more aliphatic diamines having from 10 to 20 carbon atoms, and, optionally, from one or more additional diamines;
(iii) and, optionally, from one or more aminocarboxylic acids and/or lactams, in which terephthalic acid comprises from 75 to 100 mol % of (i), the aliphatic diamine(s) having from 10 to 20 carbon atoms comprise(s) from 75 to 100 mol% of (ii), and the aminocarboxylic acid(s) or lactam(s) comprise(s) from 0 to 25 mol % of (iii) relative to the total amount (i)+(ii)+(iii).

Such polyamides, known as semiaromatic polyamides due to the presence of at least one aromatic ring in one of the units of said polyamides, actually make it possible to achieve melting points of greater than 280° C. An example of a composition comprising a semiaromatic polyamide of formula 10,12/10,T, in a molar ratio of 10/90, even has a melting point of 300° C.

Such semiaromatic polyam ides prove satisfactory not only from the point of view of the melting point values that can be attained (greater than 280° C.),but also due to the low moisture uptake that characterizes these products.

These semiaromatic polyamides are described, in particular in document WO 2006/135841, as being able, furthermore, to be incorporated into compositions that make it possible to manufacture an element that reflects the light generated by a light-emitting diode (LED).

However, although the melting point and moisture uptake values that characterize the semiaromatic polyamides described in documents US 2004/0077769 and WO 2006/135841 are compatible with the implementation of SMT technology, in particular for the assembly of LED reflectors, switches or connectors, the Applicant has observed that, among all these polyamides, a good number of them, including those which are exemplified, do not meet another essential criterion, which is resistance to thermal oxidation.

Therefore, there is a real need to find semiaromatic polyamides that can be used for the production of precision parts in the field of light-emitting diode (LED) reflectors, switches and connectors, such polyamides simultaneously having:
good thermomechanical behaviour, with melting points or heat distortion temperatures (or “HDTs” measured according to the ISO 75 standard) of at least 220° C., advantageously of at least 275° C. and, in particular, under a load of 0.45 MPa;
very low water uptake, with values typically of less than 3%, or even 2.5%, to avoid “blistering”; and
good resistance to thermal oxidation, thus making it possible both to retain very good mechanical properties and to limit yellowing.

### BRIEF DESCRIPTION OF THE INVENTION

The Applicant has found that these requirements are achieved at the same time with a semiaromatic polyamide consisting:
of 70 to 95 mol% of a first repeating unit (A) obtained from the polycondensation of at least one first linear or branched aliphatic diamine comprising from 9 to 36 carbon atoms, advantageously from 10 to 36 carbon atoms, and of at least one aromatic dicarboxylic acid; and
of 5 to 30 mol % of a second repeating unit (B) obtained from at least one lactam comprising from 9 to 12 carbon atoms and/or from at least one aminocarboxylic acid comprising from 9 to 12 carbon atoms.

The invention therefore relates to a semiaromatic polyamide consisting of at least two different repeating units, a first repeating unit (A) and a second repeating unit (B), each of these units being obtained from a particular selection of co-monomers.

Another subject of the present invention is the process for preparing said semiaromatic polyamide.

Another subject of the present invention is a composition comprising at least one semiaromatic polyamide according to the invention.

A final subject of the present invention is the use of the semiaromatic polyamide and of the composition according to the invention to form a single-layer or multilayer structure. More preferentially, the use will be envisaged for the manufacture of injection-moulded parts, such as LED reflectors, switches or connectors or other electrical and/or electronic component supports, which will be able, in particular, to be manufactured via the implementation of SMT technology.

### DETAILED DESCRIPTION OF THE INVENTION

Other features, aspects, subjects and advantages of the present invention will emerge even more clearly on reading the description which follows.

The nomenclature used to define the polyamide is described in the ISO 1874-1:1992 standard “Plastics—Polyamide (PA) moulding and extrusion materials—Part 1: Designation”, especially on page 3 (Tables 1 and 2) and is well known to a person skilled in the art.

Furthermore, it is specified that the expression “between” used in the remainder of this description should be understood as including the limits mentioned.

According to a first aspect of the invention, the invention relates to a semiaromatic polyamide consisting:
of 70 to 95 mol % of a first repeating unit (A) obtained from the polycondensation of at least one linear or branched aliphatic diamine comprising from 9 to 36 carbon atoms, advantageously from 10 to 36 carbon atoms, and of at least one aromatic dicarboxylic acid; and
of 5 to 30 mol % of a second repeating unit (B) obtained from at least one lactam comprising from 9 to 12 carbon atoms and/or from at least one aminocarboxylic acid comprising from 9 to 12 carbon atoms. The second repeating unit (B) is obtained:
either from a lactam;
or from an aminocarboxylic acid;
of from a mixture of 2, or more, of the compounds that have just been mentioned.

This choice of second repeating unit (B) makes it possible to obtain a polyamide having a higher degree of crystallinity than a semiaromatic polyamide in which the second repeating unit originates from the condensation of a diamine with a dicarboxylic acid, the first repeating unit (A) furthermore being identical for these two semicrystalline polyamides.

This particular choice of the second repeating unit (B) also makes it possible to improve the resistance to thermal oxidation, as shown by the values that appear in Table 1 below, in which:
the homopolyamide or unit “6,10” corresponds to the condensation product of 1,6-hexanediamine and decanedioic acid; this unit has, on average, 8 carbon atoms;
the homopolyamide or unit “6,12” corresponds to the condensation product of 1,6-hexanediamine and dodecanedioic acid; this unit has, on average, 9 carbon atoms;
the homopolyamide or unit “6,14” corresponds to the condensation product of 1,6-hexanediamine and tetradecanedioic acid; this unit has, on average, 10 carbon atoms;
the homopolyamide or unit “10,10” corresponds to the condensation product of 1,10-decanediamine and decanedioic acid; this unit has, on average, 10 carbon atoms;
the homopolyamide or unit “10,12” corresponds to the condensation product of 1,10-decanediamine and dodecanedioic acid; this unit has, on average, 11 carbon atoms;
the homopolyamide or unit “11” corresponds to the unit obtained from 11-aminoundecanoic acid and has, on average, 11 carbon atoms.

In order to evaluate this resistance to thermal oxidation, oxidative ageing tests in hot air were carried out on tubes made from each of the compositions making it possible to obtain the various units listed above. These tubes all have an external diameter of 8 mm with an internal diameter of 6 mm, i.e. they have a thickness of 1 mm.

The various tubes were aged in air at 150° C., then were impacted with an impact according to the DIN 73378 standard, this impact taking place at ambient temperature (23° C.) and at −40° C. Listed in Table 1 below are the half-lives (in hours) found, which correspond to the time at the end of which 50% of the tubes tested break.

TABLE 1

| Unit | 23° C. | −40° C. |
|---|---|---|
| 6, 10 | 100 | 0 |
| 6, 12 | 150 | 0 |
| 6, 14 | 200 | 65 |
| 10, 10 | 200 | 70 |
| 10, 12 | 250 | 100 |
| 11 | 350 | 200 |

It is therefore observed that the thermal oxidation values of the homopolyamides originating from the polycondensation of a diamine with a dicarboxylic acid are much worse than that of a homopolyamide originating from the polycondensation of an aminocarboxylic acid, in particular having an equivalent number of carbon atoms (see the values discovered for the “10,12” and “11” units, whether at 23° C. or at −40° C.).

This observation can be transposed to the synthesis of semiaromatic polyamides comprising at least two different repeating units, also known as “copolyam ides”.

Surprisingly, the Applicant has observed that, in addition to their excellent thermomechanical properties, low water uptake and good resistance to thermal oxidation, the semiaromatic polyamide according to the invention has good resistance to UV radiation. The latter property confers a two-fold advantage, that of making it possible to manufacture articles that do not exhibit yellowing or exhibit very little yellowing over time, such articles also having reflectance properties that are not adversely changed either over time.

Such properties are particularly advantageous for the manufacture of parts such as light-emitting diode (or LED) reflectors.

In support of this observation, Table 2 states values of the yellow index (or “YI”, measured according to the ASTM E 313-05, D1925 standard) measured on test specimens made from some of the compositions mentioned previously and aged in air at 150° C.

TABLE 2

| Unit | YI |
|---|---|
| 6, 10 | 60 |
| 10, 10 | 50 |
| 11 | 35 |

A very slight yellowing is therefore observed with the use of an “11” unit.

In one advantageous variant, the semiaromatic polyamide according to the invention consists of 76 to 90 mol % of the first repeating unit (A) and of 10 to 24 mol % of the second repeating unit (B).

In one preferred variant, the semiaromatic polyamide according to the invention consists of 80 to 89 mol % of the first repeating unit (A) and of 11 to 20 mol % of the second repeating unit (B).

The first repeating unit (A) of the semiaromatic polyamide according to the invention is obtained from the polycondensation of at least one diamine and at least one dicarboxylic acid.

The diamine used to obtain this first repeating unit (A) is an aliphatic diamine comprising from 9 to 36 carbon atoms, advantageously from 10 to 36 carbon atoms. This diamine may be linear and then corresponds to the formula H₂N—(CH₂)ₐ—NH₂; it may also be branched and may comprise one or more methyl or ethyl substituents on the main chain.

Advantageously, the aliphatic diamine is linear and chosen from nonanediamine, decanediamine, undecanediamine, dodecanediamine, tridecanediamine, tetradecanediamine, hexadecanediamine, octadecanediamine, octadecenediamine, eicosanediamine, docosanediamine and the diamines obtained from fatty acids. The linear aliphatic diamines that have just been cited all have the advantage of being biobased, within the meaning of the ASTM D6866 standard.

Preferentially, the aliphatic diamine is linear and comprises from 10 to 12 carbon atoms and is chosen from decanediamine, undecanediamine and dodecanediamine.

To obtain this first repeating unit (A), it is possible to envisage using a single aliphatic diamine comprising from 9 to 36, advantageously from 10 to 36, carbon atoms or a mixture of two, or more, aliphatic diamines, all these aliphatic diamines necessarily comprising from 9 to 36, advantageously from 10 to 36, carbon atoms and of course being different from one another.

The dicarboxylic acid used to obtain this first repeating unit (A) is an aromatic dicarboxylic acid.

This dicarboxylic acid is advantageously chosen from terephthalic acid (denoted by T), isophthalic acid (denoted by I), naphthalenic diacids and mixtures thereof. Among the naphthalenic acids, mention may especially be made of 2,6-naphthalenedicarboxylic acid.

Preferentially, the dicarboxylic acid is terephthalic acid (denoted by T).

To obtain this first repeating unit (A), it is possible to envisage using a single aromatic dicarboxylic acid or a mixture of two, or more, dicarboxylic acids, all these dicarboxylic acids being aromatic and of course being different from one another.

The second repeating unit (B) of the semiaromatic polyamide according to the invention is obtained from at least one lactam and/or at least one aminocarboxylic acid.

The lactam used for obtaining this second repeating unit (B) is a lactam comprising from 9 to 12 carbon atoms.

Advantageously, the lactam comprises from 10 to 12 carbon atoms and is therefore chosen from decanolactam, undecanolactam and lauryllactam.

Preferentially, the lactam is lauryllactam, which comprises 12 carbon atoms.

To obtain this second repeating unit (B), it is possible to envisage using a single lactam comprising from 9 to 12 carbon atoms or a mixture of two, or more, lactams, all these lactams necessarily comprising from 9 to 12 carbon atoms and of course being different from one another.

The aminocarboxylic acid used to obtain this second repeating unit (B) is an aminocarboxylic acid comprising from 9 to 12 carbon atoms, preferably an unbranched, linear aminocarboxylic acid. It may thus be chosen from 9-aminononanoic acid, 10-aminodecanoic acid, 10-aminoundecanoic acid, 11-aminoundecanoic acid and 12-aminododecanoic acid.

Advantageously, this acid aminocarboxylic acid comprises from 10 to 12 carbon atoms.

Preferentially, the aminocarboxylic acid is 11-aminoundecanoic acid, which comprises 11 carbon atoms and which also has the advantage of being biobased, within the meaning of the ASTM D6866 standard.

To obtain this second repeating unit (B), it is possible to envisage using a single aminocarboxylic acid comprising from 9 to 12 carbon atoms or a mixture of two, or more, aminocarboxylic acids, all these aminocarboxylic acids necessarily comprising from 9 to 12 carbon atoms and of course being different from one another.

To obtain this second repeating unit (B), it is furthermore possible to envisage using a mixture of one or more lactams with one or more aminocarboxylic acids, all these lactams and aminocarboxylic acids each comprising from 9 to 12 carbon atoms and of course being different from one another.

According to a second aspect of the invention, the invention relates to a semiaromatic polyamide consisting of the first and second repeating units (A) and (B), with the following particular features:
the first repeating unit (A) being obtained from the polycondensation of a single linear or branched aliphatic diamine comprising from 9 to 36, advantageously from 10 to 36, carbon atoms and a single aromatic dicarboxylic acid.

Advantageously, the aliphatic diamine comprises from 10 to 12 carbon atoms and the aromatic dicarboxylic acid is terephthalic acid.
the second repeating unit (B) being obtained from a single lactam comprising from 9 to 12 carbon atoms or from a single aminocarboxylic acid comprising from 9 to 12 carbon atoms.

Advantageously, the lactam is lauryllactam and the aminocarboxylic acid is 11-aminoundecanoic acid.

Among the combinations that can be envisaged, the following semiaromatic polyamides are of particularly great interest: they are copolyamides corresponding to one of the formulae chosen from 10/9,T, 10/10,T, 10/11,T, 10/12,T, 11/9,T, 11/10,T, 11/11,T, 11/12,T, 12/9,T, 12/10,T, 12/11,T and 12/12,T.

According to a third aspect of the invention, the invention relates to a semiaromatic polyamide consisting of the first and second repeating units (A) and (B), with the following particular features:
the first repeating unit (A) being obtained from the polycondensation of a single linear or branched aliphatic diamine comprising from 9 to 36, advantageously from 10 to 36, carbon atoms and a single aromatic dicarboxylic acid.

Advantageously, the aliphatic diamine comprises from 10 to 12 carbon atoms and the aromatic dicarboxylic acid is terephthalic acid.
the second repeating unit (B) being obtained from at least two products chosen from a lactam comprising from 9 to 12 carbon atoms and an aminocarboxylic acid comprising from 9 to 12 carbon atoms.

Advantageously, the lactam is lauryllactam and the aminocarboxylic acid is 11-aminoundecanoic acid.

Among the combinations that can be envisaged, the following semiaromatic polyamides are of particularly great interest: they are copolyamides corresponding to one of the formulae chosen from 11/12/10,T, 11/12/11,T, 11/12/12,T.

According to a fourth aspect of the invention, the invention relates to a semiaromatic polyamide consisting of the first and second repeating units (A) and (B), with the following particular features:
the first repeating unit (A) being obtained from the polycondensation of a mixture of two different linear or branched aliphatic diamines each comprising from 9 to 36, advantageously from 10 to 36, carbon atoms and a single aromatic dicarboxylic acid.

Advantageously, the two aliphatic diamines each comprise from 10 to 12 carbon atoms and the aromatic dicarboxylic acid is terephthalic acid.
the second repeating unit (B) being obtained from a single lactam comprising from 9 to 12 carbon atoms or from a single aminocarboxylic acid comprising from 9 to 12 carbon atoms.

Advantageously, the lactam is lauryllactam and the aminocarboxylic acid is 11-aminoundecanoic acid.

Among the combinations that can be envisaged, the following semiaromatic polyamides are of particularly great interest: they are copolyamides corresponding to one of the formulae chosen from 10/10,T/11,T, 10/10,T/12,T, 10/11,T/12,T, 11/10,T/11,T, 11/10,T/12,T, 11/11,T/12,T, 12/10,T/11,T, 12/10,T/12,T and 12/11,T/12,T.

According to a fifth aspect of the invention, the invention relates to a semiaromatic polyamide consisting of the first and second repeating units (A) and (B), with the following particular features:
the first repeating unit (A) being obtained from the polycondensation of a single linear or branched aliphatic diamine comprising from 9 to 36, advantageously from 10 to 36, carbon atoms and two different aromatic dicarboxylic acids.

Advantageously, the aliphatic diamine comprises from 10 to 12 carbon atoms and the two aromatic dicarboxylic acids are terephthalic acid and isophthalic acid.
the second repeating unit (B) being obtained from a single lactam comprising from 9 to 12 carbon atoms or from a single aminocarboxylic acid comprising from 9 to 12 carbon atoms.

Advantageously, the lactam is lauryllactam and the aminocarboxylic acid is 11-aminoundecanoic acid.

Among the combinations that can be envisaged, the following semiaromatic polyamides are of particularly great interest: they are copolyamides corresponding to one of the formulae chosen from 10/10,T/10,I, 11/9,T/9,I, 11/10,T/10,I, 11/11,T/11,I, 11/12,T/12,I, 12/9,T/9,I, 12/10,T/10,I, 12/11,T/11,I and 12/12,T/12,I.

Without going further into the details, the present invention also covers semiaromatic polyamides consisting of the first and second repeating units (A) and (B), in which the features explained in detail above for the aliphatic diamine(s) and the aromatic dicarboxylic acid(s) of the first repeating unit (A) and for the lactam(s) and/or aminocarboxylic acid(s) of the second repeating unit (B) are combined with one another.

One advantage of the semiaromatic polyamide according to the invention is that it may comprise monomers originating from resources derived from renewable raw materials, that is to say comprising organic carbon derived from biomass and determined according to the ASTM D6866 standard. These monomers derived from renewable raw materials may especially be 1,10-decanediamine or else 11-aminoundecanoic acid.

The invention also relates to a process for preparing a semiaromatic polyamide as defined above.

This process comprises a step of polycondensation of the comonomers leading to the first repeating unit (A) and to the second repeating unit (B) constituting the semiaromatic polyamide according to the invention.

This polycondensation step may be carried out according to a continuous or batch process.

This step of polycondensation of the comonomers leading to the first repeating unit (A) and to the second repeating unit (B) may be carried out in the presence of chain-terminating agents, this being done in amounts predetermined according to the particular semiaromatic polyamide desired.

Described below are various variants of the process for preparing a semiaromatic polyamide according to the second aspect of the invention, said polyamide being obtained from three comonomers, a single lactam, a single aliphatic diamine (referred to hereinbelow as “diamine”) and a single aromatic dicarboxylic acid (referred to hereinbelow as “diacid”).

Of course, that which will be described can be transposed to the preparation of a semiaromatic polyamide according to the second aspect of the invention which uses an aminocarboxylic acid in place of the lactam but also to the preparation of a semiaromatic polyamide according to the other aspects of the invention envisaged above.

According to a first embodiment of the process according to the present invention, said preparation process comprises a single step of polycondensation reaction between the lactam and the stoichiometric combination of the diamine and of the diacid. This step may be conducted in the presence of sodium hypophosphite, and at least one chain-terminating agent, water and optionally other additives.

According to a second embodiment of the process according to the present invention, said preparation process comprises two steps. The first step results in a diacid oligomer being obtained, which will polycondense with the diamine during the second step, according to the following sequence:
a first step of reaction between the diacid and the lactam, in the presence of a hypophosphite salt; and
a second step of reaction of the diacid oligomer thus formed in the first step with the diamine.

The optional chain-terminating agent or agents are introduced during the first and/or second step.

According to a third embodiment of the process according to the present invention, said preparation process comprises two steps:
a first step of reaction of the lactam with the diacid, and with 10 to 90% by weight of the diamine, in the presence of a hypophosphite salt; and
a second step of reaction of the oligomer produced in the first step with the balance of the diamine on one or more occasions.

The chain-terminating agent or agents are introduced during the first and/or second step.

According to a fourth embodiment of the process according to the present invention, said preparation process comprises two steps:
a first step of reaction of the lactam with the diacid and all of the diamine, in the presence of a hypophosphite salt; an oligomer is obtained by emptying the reactor under steam pressure and crystallization of said oligomer;
a second step of post-polymerization, at atmospheric pressure or under vacuum, of the oligomer produced in the first step.

The chain-terminating agent or agents are introduced during the first and/or second step.

This prepolymer may be taken up directly or with intermediate storage in a solid form (granular or powder form, for example), in order to bring the polycondensation to completion. This operation is referred to as “rise in viscosity”. This rise in viscosity can be produced on a reactor of extruder type at atmospheric pressure or under vacuum.

The processes according to the present invention can be carried out in any reactor conventionally used in polymerization, such as reactors comprising anchor or ribbon stirrers. However, when the process comprises a second step as defined above, it can also be carried out in a horizontal reactor or finisher, more commonly referred to by a person skilled in the art as a “finisher”.

The present invention also relates to a composition comprising at least one semiaromatic polyamide as defined above.

A composition according to the invention may also comprise at least one customary additive for polyamides.

Among these additives, mention may especially be made of fillers, fibres, flame retardants, flame retardant synergists, dyes, stabilizers (such as UV stabilizers), plasticizers, impact modifiers, surfactants, pigments, optical brighteners, antioxidants, natural waxes, and mixtures thereof.

Advantageously, the additives represent up to 90%, advantageously from 1 to 60%, preferably from 10 to 40% and, more preferentially, of the order of 30% by weight relative to the total weight of the composition.

The fillers envisaged within the context of the present invention include nanofillers, such as carbon nanotubes, conventional inorganic fillers, such as kaolin, magnesia, talc, wollastonite and scorias.

Among the fibres envisaged within the context of the present invention, mention may be made of glass fibres and carbon fibres. The glass fibres used more generally have a size which is advantageously between 0.20 and 25 mm. It is possible to include therein a coupling agent for improving the adhesion of the fibers to the semiaromatic polyamide, such as silanes or titanates, which are known to a person skilled in the art. Anionic fillers can also be used, such as graphite or aramid fibers (aramids are completely aromatic polyamides).

Preferably, the glass fibers are present in the composition generally in a content of 10 to 50% by weight, preferably of the order of 30% by weight, relative to the total weight of the composition.

A composition according to the invention may comprise, the percentages by weight being expressed relative to the total weight of the composition:
at least 40% by weight of the polyamide according to the invention,
from 10 to 60% by weight of glass fibres,
from 0 to 30%, preferably from 0 to 8% by weight of flame retardant, optionally comprising a flame retardant synergist.

Among the flame retardants that are known, mention may also be made of melamine cyanurate and also phosphorus, and its derivatives such as red phosphorus (U.S. Pat. No. 3,778,407), phosphites, phosphates and phosphinates. Mention may also be made of the flame retardants and flame retardant synergists described in document FR 2 900 409, which are particularly suitable for compositions based on semiaromatic polyamides.

It is specified that by adding phosphorus additives, some of which may moreover be flame retardants, the reflectance of the parts obtained from the composition according to the invention is further improved.

Among the pigments capable of being introduced into a composition according to the invention, mention may be made of white pigments such as titanium dioxide.

Indeed, white pigments also make it possible to improve the reflectance of the parts obtained from such compositions according to the invention. The corresponding compositions then have a major advantage for use in the manufacture of parts such as LED reflectors.

Advantageously, the weight proportion of pigments, especially of white pigments, is between 10 and 40% relative to the total weight of the composition.

Thus, a composition according to the invention may also comprise, the percentages by weight being expressed relative to the total weight of the composition:
at least 40% by weight of the polyamide according to the invention,
from 10 to 40% by weight of pigments, such as titanium dioxide,
from 0 to 60% by weight of glass fibres,
from 0 to 30%, preferably from 0 to 8% by weight of flame retardant, optionally comprising a flame retardant synergist.

A composition according to the invention may also comprise, in addition, at least one second polymer.

Advantageously, this second polymer may be chosen from a semicrystalline polyamide, an amorphous polyamide, a semicrystalline copolyamide, an amorphous copolyamide, a polyetheramide, a polyesteramide, an aromatic polyester, an arylamide and blends thereof.

This second polymer may also be chosen from starch, which may be modified and/or formulated, cellulose or its derivatives, such as cellulose acetate or cellulose ethers, polylactic acid, polyglycolic acid and polyhydroxyalkanoates.

In particular, this second polymer may be one or more functional or non-functional and crosslinked or uncrosslinked polyolefins.

The compositions comprising a semiaromatic polyamide according to the invention may be prepared by any method that makes it possible to obtain a homogenous mixture, such as extrusion in the melt state, compacting or else a roll mill.

More particularly, the composition according to the invention is prepared by melt blending all the ingredients in a process said to be a direct process.

Advantageously, the composition may be obtained in the form of granules by compounding on a device known to a person skilled in the art such as a twin-screw extruder, co-kneader or internal mixer.

The composition according to the invention obtained by the preparation process described above may then be converted for a subsequent conversion or use known to a person skilled in the art using devices such as an injection-moulding press or else an extruder.

The invention thus also relates to an article obtained by injection moulding, extrusion, extrusion-blow moulding, coextrusion, or multi-injection moulding from at least one composition as defined above.

The process for preparing the composition according to the invention may also use a twin-screw extruder feeding, without intermediate granulation, an injection-moulding press or an extruder according to a processing device known to a person skilled in the art.

The present invention also relates to the use of a semiaromatic polyamide as described above or of a composition as described above for forming a powder, granules, a single-layer structure or at least one layer of a multilayer structure.

The semiaromatic polyamide as described above or the composition as described above comprising such a polyamide may be used for obtaining parts.

Among these parts, mention will very particularly be made of injection-moulded parts such as light-emitting diode (LED) reflectors, switches and connectors and electrical and electronic component supports, it being possible for such parts to be intended for the industrial field in general, and for the electrical and electronics industry in particular.

Such parts may very particularly be obtained by SMT technology from the semiaromatic polyamide or the composition according to the invention. This semiaromatic polyamide or this composition may in particular be used as a brazing composition.

Such parts, whether they are electronic or not, may generally also be used in fluid transport, in the automotive field, especially parts positioned in the engine or under the bonnet, and in the industrial field in general.

1-15. (canceled)

16. Semiaromatic polyamide consisting:
of 70 to 95 mol % of a first repeating unit (A) obtained from the polycondensation of at least one linear aliphatic diamine comprising from 10 to 36 carbon atoms and of at least one aromatic dicarboxylic acid; and
of 5 to 30 mol % of a second repeating unit (B) obtained from at least one lactam comprising from 9 to 12 carbon atoms and/or from at least one aminocarboxylic acid comprising from 9 to 12 carbon atoms.

17. Semiaromatic polyamide according to claim 16, characterized in that it consists of 76 to 90 mol % of the first repeating unit (A) and of 10 to 24 mol % of the second repeating unit (B).

18. Semiaromatic polyamide according to claim 16, characterized in that it consists of 80 to 89 mol % of the first repeating unit (A) and of 11 to 20 mol % of the second repeating unit (B).

19. Semiaromatic polyamide according claim 16, characterized in that the linear aliphatic diamine comprises from 10 to 12 carbon atoms.

20. Semiaromatic polyamide according to claim 16, characterized in that the aromatic dicarboxylic acid is chosen from terephthalic acid (denoted by T), isophthalic acid (denoted by I), naphthalenic acids and mixtures thereof.

21. Semiaromatic polyamide according to claim 20, characterized in that the aromatic dicarboxylic acid is terephthalic acid (denoted by T).

22. Semiaromatic polyamide according to claim 16, characterized in that the lactam comprises from 10 to 12 carbon atoms, preferably 12 carbon atoms.

23. Semiaromatic polyamide according to claim 16, characterized in that the aminocarboxylic acid comprises from 10 to 12 carbon atoms, preferably 11 carbon atoms.

24. Semiaromatic polyamide according to claim 16, characterized in that it corresponds to one of the following formulae: 10/10,T, 11/10,T, 12/10,T, 10/11,T, 11/11,T, 12/11,T, 10/12,T, 11/12,T, 12/12,T, 10/10,T/11,T, 11/10,T/12,T, 12/10,T/12,T, 10/10,T/10,I, 11/10,T/10,I and 12/10,T/10,I.

25. Process for preparing the semiaromatic polyamide according to claim 16, characterized in that it comprises a step of polycondensation of the comonomers leading to the first repeating unit (A) and to the second repeating unit (B).

26. Composition comprising at least one semiaromatic polyamide according to claim 16.

27. Composition according to claim 26, characterized in that it comprises, in addition, at least one additive chosen from fillers, fibres (carbon and/or glass fibres), flame retardants, flame retardant synergists, dyes, stabilizers, plasticizers, impact modifiers, surfactants, pigments, brighteners, antioxidants, natural waxes and mixtures thereof.

28. In an electronic part in the electrical or electronics industry comprising a polymer, the improvement wherein the polymer is a semiaromatic polyamide as defined in claim 16.

29. The electronic part according to claim 28 is a light-emitting diode (or LED) reflector, switch or connector.

30. The electronic part according to claim 28, employing surface-mount technology (SMT).
